(19) United States
(12) Patent Application Publication
(10) Pub. No.: US 2023/0234034 A1
(43) Pub. Date: Jul. 27, 2023

(54) ALUMINIUM AND ZIRCONIUM-BASED MIXED OXIDE

(71) Applicant: RHODIA OPERATIONS, Lyon (FR)

(72) Inventors: Naotaka Ohtake, Tokushima (JP); Toshihiro Sasaki, Tokushima (JP); Kaoru Nishimura, Tokushima (JP)

(73) Assignee: RHODIA OPERATIONS, Lyon (FR)

(21) Appl. No.: 17/928,224

(22) PCT Filed: May 16, 2021
(86) PCT No.: PCT/EP2021/062905

§ 371 Date: Nov. 28, 2022

(30) Foreign Application Priority Data
May 28, 2020 (EP) 20315276.4

(51) Int. Cl. B01J 23/12; B01J 23/42; B01J 23/46; B01J 23/44; B01J 35/10; B01J 37/04; B01J 37/03; B01J 37/08; B01J 37/00; C01G 25/00

(52) U.S. Cl. CPC B01J 23/12; B01J 23/42; B01J 23/44; B01J 23/462; B01J 35/1009; B01J 35/1014; B01J 35/1019; B01J 35/1038; B01J 35/1061; B01J 37/04; B01J 37/0018; B01J 37/031; B01J 37/088; C01G 25/006; C01P 2002/50; C01P 2002/60; C01P 2002/72; C01P 2006/13; C01P 2006/14; C01P 2006/16

(57) ABSTRACT

The present invention relates to a mixed oxide of aluminium, of zirconium, of cerium, of lanthanum and optionally of at least one rare-earth metal other than cerium and lanthanum that makes it possible to repair a catalyst that retains, after severe ageing, a good thermal stability and a good catalytic activity. The invention also relates to the process for preparing this mixed oxide and also to a process for treating exhaust gases from internal combustion engines using a catalyst prepared from this mixed oxide.

### TECHNICAL FIELD

The present invention relates to a mixed oxide of aluminium, of zirconium, of lanthanum and optionally of at least one rare-earth metal other than cerium and lanthanum that makes it possible to prepare a catalyst that retains, after severe ageing, a specific porosity, a good thermal stability and a good catalytic activity. The invention also relates to the process for preparing this mixed oxide and also to a process for treating exhaust gases from internal combustion engines using a catalyst prepared from this mixed oxide.

### Technical Problem

In an exhaust system for exhaust gas that connects a vehicle engine and a muffler to each other, a catalytic converter for purifying exhaust gas is generally provided. The engine emits environmentally harmful materials such as CO, NOₓ or unburned hydrocarbons. In order to convert such harmful materials into environmentally acceptable materials, the exhaust gas is caused to flow through a catalytic converter such that CO is converted into CO₂, NOₓ are converted into N₂ and O₂ and the unburnt hydrocarbons are burnt. In the catalytic converter, catalyst layers having a precious metal catalyst such as Rh, Pd, or Pt supported on a support are formed on cell wall surfaces of a substrate. Examples of the support for supporting the precious metal catalyst include mixed oxides based on cerium and zirconium. This support is also called a co-catalyst and is an essential component of the three way catalyst which simultaneously removes harmful components in exhaust gas such as CO, NOₓ and unburnt hydrocarbons. Cerium is important as the oxidation number of cerium changes depending on the partial pressure of oxygen in the exhaust gas. CeO₂ has a function of adsorbing and desorbing oxygen and a function of storing oxygen (what is called OSC capacity).

Rh is known to be an efficient precious metal to reduce the NOₓ content from the exhaust gas. Rh⁰ is preferred than Rh in high oxidation state like Rh^{lll} because it provides a better DeNOₓ activity. It is known that in traditional three way catalysts in which a cerium zirconium based mixed oxide is used as a cocatalyst and a support for the precious metal(s) that the presence of cerium oxide is detrimental to the DeNOₓ activity because Rh⁰ is oxidized into Rh^{lll} from the desorbed oxygen from CeO₂.

Zirconia is known as a good support for rhodium since it helps stabilize and disperse Rh⁰ but there is a need for a better thermal stability of the catalyst, in particular to keep an effective DeNOₓ activity over time.

There is therefore a need for a support for rhodium having a specific porosity for a good mass transfer which remains thermally stable under the harsh conditions encountered in the catalytic converter (high temperatures and presence of aggressive gases such as CO, O₂ and NOₓ) and allows an efficient DeNOₓ catalytic activity over time, in particular an efficient catalytic activity of rhodium over time.

The mixed oxide of the invention aims to solve this problem.

It is specified, for the continuation of the description, that, unless otherwise indicated, in the ranges of values which are given including for the expressions such as “at most” and “at least”, the values at the limits are included. Moreover, wt% corresponds to % expressed by weight. It is also specified that unless indicated otherwise, the calcinations are performed in air.

### TECHNICAL BACKGROUND

EP 3085667 discloses a zirconia based body exhibiting a P/W ratio of 0.03 or more after heat treatment at 1000° C. for 12 hours wherein P denotes the height of the peak and W the width of the peak. The P/W ratios of the disclosed products is between 0.01 and 0.11 which corresponds to a high W/P ratio between 9 and 100.

EP 3345870 discloses a zirconia powder comprising between 2 to 6 mol% of yttria that may also comprise aluminium oxide with a content lower than 2.0%.

US 9,902,654 B2 discloses a ZrO₂—Al₂O₃ ceramic. A specific composition of ceramic with 80 wt% (97 mol% ZrO₂— 3 mol% Y₂O₃) — 20 wt% Al₂O₃ is given, which corresponds to 75.6 wt% of ZrO₂.

WO 2019/122692 discloses an aluminium hydrate H that is used for the preparation of a mixed oxide containing cerium, different from the mixed oxide of the present invention.

None of the cited documents disclose a mixed oxide as in claim 1.

### FIGURE

FIG. 1 illustrates the porosity curve (C) for the composition of example 1 obtained by the nitrogen porosimetry technique after calcining in air the mixed oxide at 950° C. for 3 hours. For this composition, Dₚ _{950°C/3} ₕ = 17 nm.

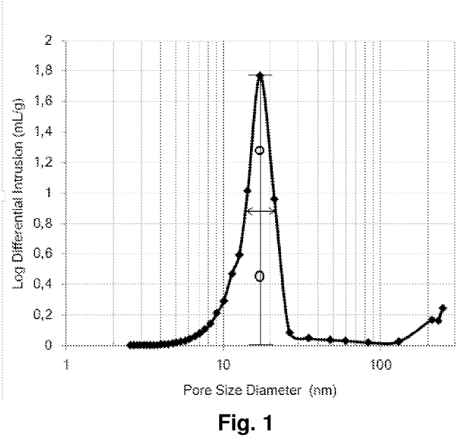

### BRIEF DESCRIPTION OF THE INVENTION

The mixed oxide of the invention is a mixed oxide of Al, Zr, La and optionally of at least one rare-earth metal other than cerium and other than lanthanum (denoted REM).

The mixed oxide of the invention is disclosed in claims 1-41. Thus, it is a mixed oxide of aluminium, of zirconium, of lanthanum and optionally of at least one rare-earth metal other than cerium and other than lanthanum (denoted REM), the proportions by weight of these elements being as follows:
between 20.0 wt% and 45.0 wt% of aluminium;
between 1.0 wt% and 15.0 wt% of lanthanum;
between 0 and 10.0 wt% for the rare-earth metal other than cerium and other than lanthanum, on condition that if the mixed oxide comprises more than one rare-earth metal other than cerium and other than lanthanum, this proportion applies to each of these rare-earth metals;
between 50.0 wt% and 70.0 wt% of zirconium;

these proportions being expressed as oxide equivalent with respect to the total weight of the mixed oxide,
characterized in that after calcination in air at 1100° C. for 5 hours, the specific surface area (BET) of the mixed oxide is at least 25 m²/g;
and in that after calcination in air at 950° C. for 3 hours, the porosity of the mixed oxide determined by N₂ porosimetry is such that:
   in the domain of the pores with a size lower than 100 nm, the porogram of the mixed oxide exhibits a peak which is located at a diameter D_{p,} _{950°C/3} ₕ between 10 and 25 nm, more particularly between 10 and 22 nm, even more particularly between 13 and 19 nm;
   the ratio V_{<30} _{nm,} _{950°C/3h} / Vₜₒₜₐₗ, _{950°C/3h} is greater than or equal to 0.85;
   Vₜₒₜₐₗ, _{950°C/3h} is greater than or equal to 0.35 ml/g;
   V_{<30} _{nm,} _{950°C/3h}, V_{total,} _{950°C/3h} denoting respectively the pore volume for the pores with a size lower than 30 nm and the total pore volume of the mixed oxide after calcination in air at 950° C. for 3 hours.

The invention relates also to the process as defined in claims 42-44, to the use of the mixed oxide as defined in one of claims 45-47, to a composition as defined in claims 48-49 and to a catalytic converter as defined in claim 50. It also relates to a use of an aluminium hydrate as defined below and in claims 51-56 for the preparation of a mixed oxide. These objects are now further defined below.

### DETAILED DESCRIPTION OF THE INVENTION

As regards the composition of the mixed oxide of the invention, the latter is a mixed oxide of aluminium, of zirconium, of lanthanum and optionally of at least one rare-earth metal other than cerium and other than lanthanum (denoted REM), the proportions by weight of these elements, expressed as oxide equivalent, with respect to the total weight of the mixed oxide being as follows:
between 20.0 wt% and 45.0 wt% of aluminium;
between 1.0 wt% and 15.0 wt% of lanthanum;
between 0 and 10.0 wt% for the rare-earth metal other than cerium and other than lanthanum, on condition that if the mixed oxide comprises more than one rare-earth metal other than cerium and other than lanthanum, this proportion applies to each of these rare-earth metals;
between 50.0 wt% and 70.0 wt% of zirconium.

A rare-earth metal (REM) is understood to mean an elements selected among the elements in the group of yttrium and of the elements of the Periodic Table with an atomic number between 57 and 71 inclusive.

In the mixed oxide, the above mentioned elements Al, La, REM (if any) and Zr are generally present in the form of oxides. The mixed oxide may therefore be defined as a mixture of oxides. However, it is not excluded for these elements to be able to be present at least partly in the form of hydroxides or of oxyhydroxides. The proportions of these elements may be determined using analytical techniques conventional in laboratories, in particular plasma torch and X-ray fluorescence. As usual in the field of mixed oxides, the proportions of these elements are given by weight of oxide equivalent with respect to the total weight of the mixed oxide.

The mixed oxide comprises the above mentioned elements in the proportions indicated but it may also comprise other elements, such as, for example, impurities. On this regard, it must be noted that the mixed oxide does not comprise cerium or cerium oxide or if cerium is detectable, it is only in the form of an impurity.

The impurities generally originate from the starting materials or starting reactants used. The total proportion of the impurities expressed by weight with respect to the total weight of the mixed oxide is generally less than 2.0 wt%, or even less than 1.0 wt%. The proportion of cerium expressed by weight of oxide CeO₂ with respect to the total weight of the mixed oxide is generally less than 1.0 wt%, even less than 0.5 wt%, or less than 0.2 wt% or less than 0.05 wt%.

The mixed oxide may also comprise hafnium, which is generally present in association with zirconium in natural ores. The proportion of hafnium with respect to the zirconium depends on the ore from which the zirconium is extracted. The Zr/Hf proportion by weight in some ores may thus be of the order of 50/1. Thus, for example, baddeleyite contains approximately 98 wt% of zirconium oxide for 2 wt% of hafnium oxide. Like zirconium, hafnium is generally present in the oxide form. However, it is not excluded for it to be able to be present at least partly in the hydroxide or oxyhydroxide form. The proportion by weight of hafnium in the mixed oxide is less than or equal to 2.0 wt%, expressed as oxide equivalent with respect to the total weight of the mixed oxide. The proportion of hafnium may be between 0 and 2.0 wt%. The proportions of the impurities and of the hafnium may be determined using inductively coupled plasma mass spectrometry (ICP-MS).

The proportions of the constituting elements Al, La, REM, Zr and possibly Hf are given as weight of oxide. It is considered that for the calculation of these proportions, zirconium oxide is in the form of ZrO₂, hafnium oxide is in the form of HfO₂, aluminium is in the form of Al₂O₃, the oxide of the rare-earth metal is in the form REM₂O₃, with the exception of praseodymium, expressed in the form Pr₆O₁₁. As an example, a mixed oxide with only one REM having the following proportions expressed as oxide equivalent 30 wt% of Al, 60 wt% of Zr, 5 wt% of La and 5 wt% of Y correspond to: 30 wt% of Al₂O₃, 60 wt% of ZrO₂, 5 wt% of La₂O₃ and 5 wt% of Y₂O₃.

In the mixed oxide according to the invention, the above mentioned elements are intimately mixed, which distinguishes the mixed oxide from a simple mechanical mixture of oxides in solid form. The intimate mixing is obtained by the precipitation step of the preparation of the mixed oxide.

The proportion by weight of aluminium is between 20.0 wt% and 45.0 wt%, more particularly between 25.0 wt% and 40.0 wt%, even more particularly between 25.0 wt% and 35.0 wt%.

The proportion by weight of lanthanum is between 1.0 wt% and 15.0 wt%, more particularly between 1.0 wt% and 10.0 wt%, even more particularly between 1.0 wt% and 7.0 wt%, or even between 2.0 wt% and 7.0 wt%.

The mixed oxide may also comprise one or more rare-earth metals other than cerium or other than lanthanum (REM). The rare-earth metal may for example be selected from yttrium, neodymium, praseodymium or a combination of these elements. The mixed oxide may for example contain only a single REM in a proportion of between 0 and 10.0 wt%. The proportion of REM may be between 1.0 wt% and 10.0 wt%, even more particularly between 1.0 wt% and 7.0 wt% or even between 2.0 wt% and 7.0 wt%.

The mixed oxide may also contain more than one REM and in this case the disclosed proportions then apply to each REM. In this case too, the total proportion of these REMs should remain less than 25.0 wt%, more particularly less than 20.0 wt%.

More particularly, the REM or one of the REMs is Y.

The mixed oxide also comprises zirconium. The proportion by weight of zirconium may be between 50.0 wt% and 70.0 wt%, more particularly between 55.0 wt% and 65.0 wt%.

A specific mixed oxide C has the following composition:
between 25.0 wt% and 35.0 wt% of aluminium;
between 1.0 wt% and 7.0 wt% of lanthanum;
between 1.0 wt% and 7.0 wt% of at least one REM;
between 55.0 wt% and 65.0 wt% of zirconium.

The proportion of lanthanum may be also between 2.0 wt% and 7.0 wt%, more particularly between 3.0 wt% and 7.0 wt%. The proportion of the REM may be also between 2.0 wt% and 7.0 wt%, more particularly between 3.0 wt% and 7.0 wt%.

The mixed oxide of the invention comprises advantageously a combination of oxides of aluminium and zirconium. For the mixed oxide of the invention and more specifically for the mixed oxide C, the total proportion of zirconium and of aluminium is preferably greater than or equal to 80.0 wt%, more particularly greater than or equal to 85.0 wt%.

### Characterization of the Mixed Oxide

### Crystallite Size

The mixed oxide is characterized by the fact that after calcination in air:
at 1100° C. for 5 hours, the mean size of the crystallites of the crystalline phase based on zirconium oxide is at most 28 nm, or at most 25 nm, or even at most 22 nm; and/or
at 1200° C. for 5 hours, the mean size of the crystallites of the crystalline phase based on zirconium oxide is at most 44 nm, or at most 35 nm, or even at most 33 nm.

At 1100° C. for 5 hours, the mean size of the crystallites of the crystalline phase based on zirconium oxide is at most 28 nm. It is preferably at most 25 nm, more preferably at most 22 nm.

At 1200° C. for 5 hours, the mean size of the crystallites of the crystalline phase based on zirconium oxide is at most 44 nm. It is preferably at most 35 nm, more preferably at most 33 nm.

The crystalline phase based on zirconium oxide is generally characterized by a peak located at a 2θ angle between 29° and 31° (source: CuKα1, λ=1.5406 Angstrom). The peak is generally located at a 2θ angle between 29.0° and 31.0° (source: CuKα1, λ=1.5406 Angstrom).

Said crystalline phase comprises zirconium oxide and may also contain lanthanum and optionally the rare-earth metal(s) other than cerium and other than lanthanum.

Said crystalline phase generally exhibits a tetragonal structure. The tetragonal structure may be characterized thex-ray diffraction technique or by Raman spectroscopy. When the x-ray diffraction technique is used, the tetragonal structure is preferably is identified after calcining in air the mixed oxide at a temperature of 950° C. for 3 hours.

The mean size of the crystallites is determined by the x-ray diffraction technique. It corresponds to the size of the coherent domain calculated from the width of the diffraction line 2θ and using the Scherrer equation. According to the Scherrer equation, t is given by formula (I):

$$\text{t} = \text{k} \text{λ} / \left(\text{β} cos \text{θ}\right)$$

t: mean crystallite size;
k: shape factor equal to 0.9;
λ (lambda): wavelength of the incident beam (λ=1.5406 Angstrom);
β: line broadening measured at half the maximum intensity;
θ: Bragg angle

One usually takes into account the broadening due to the instrument to determine β.

In formula (II), the broadening due to the instrument is s and one can use the following equation:

$$t - \frac{k ⋅ λ}{\sqrt{{H}^{2} - {s}^{2}} ⋅ cos θ}$$

t: mean crystallite size;
k: shape factor equal to 0.9;
λ (lambda): wavelength of the incident beam (λ=1.5406 Angstrom);
H: full width at half maximum of the diffraction line;
s: instrumental line broadening;
θ: Bragg angle.

s depends on the instrument used and on the 2θ (theta) angle.

### Specific Surface Area

The mixed oxide according to the invention also has a large specific surface area. Specific surface area is understood to mean the BET specific surface area obtained by nitrogen adsorption. It is determined using the well-known Brunauer-Emmett-Teller method.

The BET method is in particular described in the journal “The Journal of the American Chemical Society, 60, 309 (1938)”. It is possible to comply with the recommendations of the standard ASTM D3663 - 03. Hereinafter, the abbreviation S_{T(°C)} _{/} _{×} ₍ₕ₎ is used to denote the specific surface area of a composition, obtained by the BET method, after calcination of the composition at a temperature T, expressed in °C, for a period of time of x hours. For example, S_{1100°C/5} ₕ denotes the BET specific surface area of a composition after calcination thereof at 1100° C. for 5 hours.

In order to determine the specific surface areas by nitrogen adsorption, use may be made of the following devices, Flowsorb II 2300 or Tristar 3000 of Micromeritics, according to the guidelines of the constructor. They may also be determined automatically with a Macsorb analyzer model I-1220 of Mountech according to the guidelines of the constructor. Prior to the measurement, the samples are preferably degassed under vacuum and by heating at a temperature of at most 300° C. to remove the adsorbed volatile species.

The specific surface area S_{1100°C/5} ₕ is at least 25 m²/g. This specific surface area may be preferably at least 28 m²/g, more preferably at least 30 m²/g, even more preferably at least 31 m²/g. This specific may thus be between 25 and 40 m²/g, more particularly between 28 and 40 m²/g, more particularly still between 31 and 40 m²/g. This specific surface area may be at most 40 m²/g, more particularly at most 35 m²/g. This specific surface area may also be at least 35 m²/g.

The specific surface area S_{950°C/3} ₕ may be at least 65 m²/g, more preferably at least 80 m²/g, even more preferably at least 85 m²/g. This specific surface area may be at most 110 m²/g, more particularly at most 95 m²/g, or at most 90 m²/g.

The specific surface area S_{1200°C/5} ₕ may be at least 9 m²/g, more preferably at least 10 m²/g, more preferably at least 12 m²/g. This specific surface area may be at most 15 m²/g..

### Nitrogen Porosimetry

The mixed oxide is also characterized by a specific porosity which allows a good mass transfer and a good dispersion of the precious metal. In the context of the invention, the specific porosity is given for the mixed oxide after calcination in air at 950° C. for 3 hours.

The data relating to the porosity disclosed in the present application were obtained by nitrogen porosimetry technique. With this technique, it is possible to define the pore volume (V) as a function of the pore diameter (D). More precisely, from the nitrogen porosity data, it is possible to obtain the curve (C) representing the derivative (dV/dlogD) of the function V as a function of log D. The derivative curve (C) may exhibit one or more peaks each located at a diameter denoted by Dₚ. It is also possible to obtain, from these data, the following characteristics relating to the porosity of the mixed oxide:
the total pore volume in ml/g (denoted by Vₜₒₜₐₗ) obtained from the porosimetry data as read on the cumulative curve;
the pore volume in ml/g developed by the pores, the size of which is less than or equal to 30 nm (denoted by V_{<30} ₙₘ) obtained from the porosimetry data as read on the cumulative curve.

When these parameters are determined after calcining in air the mixed oxide at 950° C. for 3 hours, they are denoted respectively Dₚ, _{950°C/3h}, Vₜₒₜₐₗ, _{950°C/3h} and V_{<30} _{nm,} _{950°C/3h}.

The nitrogen porosimetry technique is a well-known technique, very often applied to inorganic materials. The porosity may be made with a Tristar II 3000 device from Micromeritics. The conditions to determine the porosity can be as detailed in the examples. The nitrogen porosimetry technique may be performed in accordance with ASTM D4641 - 17.

In the domain of the pores with a size lower than 100 nm, the porogram of the mixed oxide after calcination in air at 950° C. for 3 hours, exhibits a peak located at a diameter D_{p,} _{950°C/3h} between 10 and 25 nm, more particularly between 10 and 22 nm, even more particularly between 13 and 19 nm. Said porogram may exhibit more than one peak in the domain of the pores with a size lower than 100 nm but the peak located at a diameter D_{p,} _{950°C/3h} between 10 and 25 nm, more particularly between 10 and 22 nm, even more particularly between 13 and 19 nm is the highest. Yet, after calcination in air at 950° C. for 3 hours, there is generally only one peak in the domain of the pores with a size lower than 100 nm and said peak is located at a diameter D_{p,} _{950°C/3} ₕ between 10 and 25 nm, more particularly between 10 and 22 nm, even more particularly between 13 and 19 nm. Thus, the invention also relates to a mixed oxide of aluminium, of zirconium, of lanthanum and optionally of at least one rare-earth metal other than cerium and other than lanthanum (denoted REM), the proportions by weight of these elements being as follows:
between 20.0 wt% and 45.0 wt% of aluminium;
between 1.0 wt% and 15.0 wt% of lanthanum;
between 0 and 10.0 wt% for the rare-earth metal other than cerium and other than lanthanum, on condition that if the mixed oxide comprises more than one rare-earth metal other than cerium and other than lanthanum, this proportion applies to each of these rare-earth metals;
between 50.0 wt% and 70.0 wt% of zirconium;

these proportions being expressed as oxide equivalent with respect to the total weight of the mixed oxide,
characterized in that after calcination in air at 1100° C. for 5 hours, the specific surface area (BET) of the mixed oxide is at least 25 m²/g;
and in that after calcination in air at 950° C. for 3 hours, the porosity of the mixed oxide determined by N₂ porosimetry is such that:
   in the domain of the pores with a size lower than 100 nm, the porogram of the mixed oxide exhibits a single peak and this peak is located at a diameter D_{p,} _{950°C/3} ₕ between 10 and 25 nm, more particularly between 10 and 22 nm, even more particularly between 13 and 19 nm;
   the ratio V_{<30} _{nm,} _{950°C/3h} / Vₜₒₜₐₗ, _{950°C/3h} is greater than or equal to 0.85;
   V_{total,} _{950°C/3h} is greater than or equal to 0.35 ml/g;
   V_{<30} _{nm,} _{950°C/3h}, Vₜₒₜₐₗ, _{950°C/3h} denoting respectively the pore volume for the pores with a size lower than 30 nm and the total pore volume of the mixed oxide after calcination in air at 950° C. for 3 hours.

The ratio V_{<30} _{nm,} _{950°C/3h} / V_{total,} _{950°C/3h} is greater than or equal to 0.85. This ratio may preferably be greater than or equal to 0.90.

V_{total,} _{950°C/3h} is also greater than or equal to 0.35 ml/g. V_{total,} _{950°C/3h} may preferably be greater than or equal to 0.40 ml/g, even more preferably greater than or equal to 0.45 ml/g.

In addition, the width at half peak of said peak located at a diameter D_{p,} _{950°C/3} ₕ between 10 and 25 nm, more particularly between 10 and 22 nm, even more particularly between 13 and 19 nm is at most 10 nm, more particularly at most 8 nm. This shows that the process of the invention makes it possible to finetune the porosity.

The mixed oxide is generally in the powder form.

All what is disclosed above remains applicable to a mixed oxide consisting essentially or consisting of a combination of the oxides of aluminium, of zirconium, of lanthanum, optionally of at least one rare-earth metal other than cerium and other than lanthanum (denoted REM), and optionally of hafnium, the proportions by weight of these elements being as follows:
between 20.0 wt% and 45.0 wt% of aluminium;
between 1.0 wt% and 15.0 wt% of lanthanum;
between 0 and 10.0 wt% for the rare-earth metal other than cerium and other than lanthanum, on condition that if the mixed oxide comprises more than one rare-earth metal other than cerium and other than lanthanum, this proportion applies to each of these rare-earth metals;
a proportion of hafnium lower than or equal to 2.0 wt%;
between 50.0 wt% and 70.0 wt% of zirconium;

these proportions being expressed as oxide equivalent with respect to the total weight of the mixed oxide,
characterized in that after calcination in air at 1100° C. for 5 hours, the specific surface area (BET) of the mixed oxide is at least 25 m²/g;
and in that after calcination in air at 950° C. for 3 hours, the porosity of the mixed oxide determined by N₂ porosimetry is such that:
   in the domain of the pores with a size lower than 100 nm, the porogram of the mixed oxide exhibits a peak which is located at a diameter D_{p,} _{950°C/} ₃ₕ between 10 and 25 nm, more particularly between 10 and 22 nm, even more particularly between 13 and 19 nm;
   the ratio V_{<30} _{nm,} _{950°C/3h} / V_{total,} _{950°C/3h} is greater than or equal to 0.85;
   V_{total,} _{950°C/3h} is greater than or equal to 0.35 ml/g;
   V_{<30} _{nm,} _{950°C/3h}, V_{total,} _{950°C/3h} denoting respectively the pore volume for the pores with a size lower than 30 nm and the total pore volume of the mixed oxide after calcination in air at 950° C. for 3 hours.

### Process of Preparation of the Mixed Oxide

As regards the preparation of the mixed oxide according to the invention, it may be according to processes (A) or (B) disclosed below. Process (A) comprises the following steps:
(a1) an acidic aqueous dispersion comprising nitric acid and precursors of oxides of zirconium, of lanthanum and optionally of a rare-earth metal other than cerium and lanthanum, in which an aluminium hydrate is dispersed, is introduced into a stirred tank containing a basic aqueous solution;
(a2) the dispersion obtained at the end of step (a1) is heated and stirred at a temperature which is at least 130° C.;
(a3) the solid of the dispersion of step (a2) is recovered by a solid/liquid separation and the cake is washed with water;
(a4) the solid obtained at the end of step (a3) is calcined in air at a temperature which is at least 800° C.

Process (A) does not comprise any step wherein a texturing agent such as lauric acid is added.

### Step (a1)

In step (a1), use is made of an aqueous acidic dispersion comprising precursors of oxides of zirconium, of lanthanum and optionally of one or more rare-earth metals other than cerium and other than lanthanum, nitric acid in which an aluminium hydrate, for example an aluminium monohydrate, is dispersed. The aqueous acidic dispersion does not comprise any precursor of cerium oxide.

The precursor of zirconium oxide may be zirconyl nitrate. Zirconyl nitrate may for instance be crystalline. The precursor of zirconium oxide may also be obtained by dissolving zirconium basic carbonate or zirconium oxyhydroxide with nitric acid. This acid attack may preferably be carried out with a NO₃⁻/Zr molar ratio of between 1.4 and 2.3. Thus, a usable zirconium nitrate solution, resulting from the attack of the carbonate, may have a concentration, expressed as ZrO₂, of between 250 and 350 g/l. For example, the zirconyl nitrate solution used in example 1 resulting from the attack of the carbonate has a concentration of 295 g/l.

The precursor of lanthanum oxide may be lanthanum nitrate. The precursor of the oxide of rare-earth metal other than cerium and lanthanum may be a nitrate or chloride. For example, it may be praseodymium nitrate, neodymium nitrate, yttrium chloride YCl₃ or yttrium nitrate Y(NO₃)₃.

According to one embodiment, the precursors of the oxides of Zr, of La and of REM(s) are all in the form of nitrates.

The aqueous acidic dispersion also contains nitric acid. The concentration of H⁺ in the aqueous acidic dispersion is advantageously between 0.04 and 3.0 mol/l, more particularly between 0.5 and 2.0 mol/l. The amount of H⁺ should be high enough to obtain a dispersion in which the particles of aluminium hydrate are well dispersed.

The aqueous acidic dispersion also contains an aluminium hydrate, more particularly one based on a boehmite and optionally comprising also lanthanum. The aluminium hydrate is more preferably the one having a particular porosity which is described in WO 2019/122692 and is denoted hereinafter as aluminium hydrate H. This particular aluminium hydrate H is well dispersible in the aqueous acidic medium.

### About the Aluminium Hydrate H

This aluminium hydrate H is based on a boehmite optionally comprising also lanthanum characterized in that after having been calcined in air at a temperature of 900° C. for 2 hours, it exhibits:
a pore volume in the domain of the pores having a size of less than or equal to 20 nm (denoted by VP20 nm-N2), such that VP20 nm-N2:
   is greater than or equal to 10% x VPT-N2, more particularly greater than or equal to 15% x VPT-N2, or even greater than or equal to 20% x VPT-N2, or even greater than or equal to 30% x VPT-N2;
   is less than or equal to 60% x VPT-N2;
a pore volume in the domain of the pores having a size of between 40 and 100 nm (denoted by VP40-100 nm-N2), such that VP40-100 nm-N2 is greater than or equal to 20% x VPT-N2, more particularly greater than or equal to 25% x VPT-N2, or even greater than or equal to 30% x VPT-N2;
VPT-N2 denoting the total pore volume of the aluminium hydrate after calcination in air at 900° C. for 2 hours;
the pore volumes being determined by the nitrogen porosimetry technique.

The term “boehmite” denotes, in European nomenclature and as is known, the gamma oxyhydroxide (γ—AlOOH). In the present application, the term “boehmite” denotes a variety of aluminium hydrate having a particular crystalline form which is known to a person skilled in the art. Boehmite may thus be characterized by x-ray diffraction. The term “boehmite” also covers “pseudoboehmite” which, according to certain authors, only resembles one particular variety of boehmite and which simply has a broadening of the characteristic peaks of boehmite. Boehmite is identified by x-ray diffraction through its characteristic peaks. These are given in the file JCPDS 00-021-1307 (JCPDS = Joint Committee on Powder Diffraction Standards). It will be noted that the apex of the peak (020) may be between 13.0° and 15.0° depending in particular on:
the degree of crystallinity of the boehmite;
the size of the crystallites of the boehmite.

Reference may be made to Journal of Colloidal and Interface Science 2002, 253, 308-314 or to J. Mater. Chem. 1999, 9, 549-553 in which it is stated, for a certain number of boehmites, that the position of the peak varies depending on the number of layers in the crystal or on the size of the crystallites. This apex may more particularly be between 13.5° and 14.5°, or between 13.5° and 14.485°.

When the aluminium hydrate contains lanthanum, the proportion of lanthanum is between 1.0 wt% and 8.0 wt%, more particularly between 3.0 wt% and 8.0 wt% or between 4.0 wt% and 8.0 wt%. This proportion is given by weight of La₂O₃ relative to the weight of Al₂O₃ and La₂O₃ (in other words, proportion of La in wt% = weight of La₂O₃/weight of La₂O₃+Al₂O₃ x100). In other words also, this proportion does not take into account the amount of hydrate contained in the aluminium hydrate. Of course, one takes into account the amount of La in the aluminium hydrate H in order to target a specific amount of La in the final mixed oxide. Lanthanum is generally present in the form of lanthanum oxide in the aluminium hydrate.

A convenient way of determining the proportion of La in the aluminium hydrate consists in calcining the aluminium hydrate in air and to determine the proportion of Al and La by attacking the calcined product, for example with a concentrated nitric acid solution, so as to dissolve the elements thereof in a solution which may then be analysed by techniques known to person skilled in the art, such as for example ICP. The calcination makes it also possible to determine the loss of ignition (LOI) of the hydrate. The LOI of the aluminium hydrate may be between 20.0 and 30.0%.

The boehmite contained in the aluminium hydrate, more particularly in the aluminium hydrate H, may have a mean size of the crystallites of at most 6.0 nm, or even of at most 4.0 nm, more particularly still of at most 3.0 nm. The mean size of the crystallites is determined by the x-ray diffraction technique and corresponds to the size of the coherent domain calculated from the full width at half maximum of the line (020).

The aluminium hydrate H may be in the form of a mixture of a boehmite, identifiable as was described above by the x-ray diffraction technique, and of a phase that is not visible in x-ray diffraction, in particular an amorphous phase. The aluminium hydrate H may have a % of crystalline phase (boehmite) which is less than or equal to 60%, more particularly less than or equal to 50%. This % may be between 40% and 55%, or between 45% and 55%, or between 45% and 50%. This % is determined in a manner known to a person skilled in the art. It is possible to use the following formula to determine this %: % crystallinity = intensity of the peak (120) / intensity of the peak (120) of the reference x 100 in which the intensity of the peak (120) of the aluminium hydrate and the intensity of the peak (120) of a reference are compared. The reference used in the present application is the product corresponding to example B1 of application US 2013/017947. The intensities measured correspond to the surface areas of the peaks (120) above the baseline. These intensities are determined on the diffractograms relative to a baseline taken over the 2θ angle range between 5.0° and 90.0°. The baseline is determined automatically using the software for analysing the data of the diffractogram.

The aluminium hydrate H has a particular porosity. Thus, after calcination in air at 900° C. for 2 hours, it has a pore volume in the domain of the pores having a size of less than or equal to 20 nm (denoted by VP20 nm-N2), such that VP20 nm-N2 is greater than or equal to 20% x VPT-N2, more particularly greater than or equal to 25% x VPT-N2, or even greater than or equal to 30% x VPT-N2. Furthermore, VP20 nm-N2 is less than or equal to 60% x VPT-N2.

Furthermore, after calcination in air at 900° C. for 2 hours, the aluminium hydrate H has a pore volume in the domain of the pores having a size of between 40 and 100 nm (denoted by VP40-100 nm-N2), such that VP40-100 nm-N2 is greater than or equal to 15% x VPT-N2, more particularly greater than or equal to 20% x VPT-N2, or even greater than or equal to 25% x VPT-N2, or even greater than or equal to 30% x VPT-N2. Furthermore, VP40-100 nm-N2 may be less than or equal to 65% x VPT-N2.

After calcination in air at 900° C. for 2 hours, the aluminium hydrate H may have a total pore volume (VPT-N2) of between 0.65 and 1.20 ml/g, more particularly between 0.70 and 1.15 ml/g, or between 0.70 and 1.10 ml/g. It will be noted that the pore volume thus measured is developed predominantly by the pores of which the diameter is less than or equal to 100 nm.

The aluminium hydrate H may have a BET specific surface area of at least 200 m²/g, more particularly of at least 250 m²/g. This specific surface area may be between 200 and 400 m²/g. Moreover, after calcination in air at 900° C. for 2 hours, the aluminium hydrate H may have a BET specific surface area of at least 130 m²/g, more particularly of at least 150 m²/g. This specific surface area may be between 130 and 220 m²/g. After calcination in air at 940° C. for 2 hours, followed by calcination in air at 1100° C. for 3 hours, the aluminium hydrate H may have a BET specific surface area of at least 80 m²/g, more particularly of at least 100 m²/g. This specific surface area may be between 80 and 120 m²/g.

The aluminium hydrate H may be obtained by the process comprising the following steps:
(a) introduced into a stirred tank containing an aqueous nitric acid solution are:
   an aqueous solution (A) comprising aluminium sulfate, lanthanum nitrate and nitric acid;
   an aqueous sodium aluminate solution (B);
   the aqueous solution (A) being introduced continuously throughout step (a) and the rate of introduction of the solution (B) being regulated so that the mean pH of the reaction mixture is equal to a target value of between 4.0 and 6.0, more particularly between 4.5 and 5.5;
(b) when the entire aqueous solution (A) has been introduced, the aqueous solution (B) continues to be introduced until a target pH of between 8.0 and 10.5, preferably between 9.0 and 10.0, is reached;
(c) the reaction mixture is then filtered and the solid recovered is washed with water;
(d) the solid resulting from step (c) is then dried to give the aluminium hydrate H.

More details about the process for obtaining the aluminium hydrate H are also provided in the examples of WO 2019/122692. Use may be made of the aluminium hydrate H which is disclosed in the examples of the present patent application.

The invention thus also relates to the use of aluminium hydrate H for the preparation of a mixed oxide of aluminium, of zirconium, of lanthanum and optionally of at least one rare-earth metal other than cerium and other than lanthanum (denoted REM), notably one with the proportions by weight of these elements being as follows:
between 20.0 wt% and 45.0 wt% of aluminium;
between 1.0 wt% and 15.0 wt% of lanthanum;
between 0 and 10.0 wt% for the rare-earth metal other than cerium and other than lanthanum, on condition that if the mixed oxide comprises more than one rare-earth metal other than cerium and other than lanthanum, this proportion applies to each of these rare-earth metals;
between 50.0 wt% and 70.0 wt% of zirconium;
these proportions being expressed as oxide equivalent with respect to the total weight of the mixed oxide.

The invention thus also relates to the use of aluminium hydrate H for the preparation of the mixed oxide of the invention, notably the mixed oxide as disclosed in any one of claims 1-40.

For the preparation of the aqueous acidic dispersion used in process (A), it is advantageous to keep the mixture under stirring for a sufficient duration to obtain a high specific surface area (see comparative example 1). The mixture shall preferably be stirred for a duration between 1 and 5 hours.

The aqueous acidic dispersion used in step (a1) is introduced into a stirred tank containing a basic aqueous solution so as to obtain a precipitate (so-called “reverse” precipitation). The basic compound dissolved in the basic aqueous solution may be an hydroxide, for example an alkali metal or alkaline-earth metal hydroxide. Use may also be made of secondary, tertiary or quaternary amines, as well as of ammonia. As in the example described below, use may be made of an aqueous ammonia solution. As in the example, use may be made of an aqueous ammonia solution, for example with a concentration between 3 and 5 mol/l.

The amount of base should be in excess over the amount of cations present in the aqueous acidic dispersion. This excess ensures a complete precipitation of the cations. One may use a molar ratio base/Σ cation from the precursors x valency + H⁺ from nitric acid higher than 1.2, more particularly higher than 1.4. This ratio takes into account the valency of the cations from the precursors (e.g. 2 for Zr and 3 for La).

### Step (a2)

The dispersion obtained at the end of step (a1) is heated and stirred at a temperature which is at least 130° C. The temperature may be between 130° C. and 200° C., more particularly between 130° C. and 170° C. The duration of step (a2) is generally between 10 min and 5 hours, more particularly between 1 hour and 3 hours. For example, the dispersion may be heated at 150° C. and maintained at this temperature for 2 hours.

Under the temperature conditions given above, step (a2) may conveniently performed in a closed vessel. It may thus be specified, by way of illustration, that the pressure in the closed vessel may vary between a value greater than 1 bar (10⁵ Pa) and 165 bar (1.65 × 10⁷ Pa), preferably between 5 bar (5 × 10⁵ Pa) and 165 bar (1.65 × 10⁷ Pa).

### Step (a3)

The solid of the dispersion of step (a2) is recovered by a solid/liquid separation and the cake is washed with water. It is convenient to use a diluted ammonia solution to wash the cake. Use may for example be made of a vacuum filter, for example of Nutsche type, a centrifugal separation or a filter press.

Of course, the cake recovered at the end of step (a3) may still contain some residual water, but this has no real impact on the quality of the mixed oxide. Yet, the cake may be optionally dried to remove some residual water.

### Step (a4)

The solid obtained at the end of step (a3) is calcined in air at a temperature which is at least 800° C. The temperature of calcination should be high enough to transform the solid into the mixed oxide and to develop its crystallinity. The temperature should not be too high to maintain a high specific surface area. The temperature of calcination may be between 800° C. and 1200° C., more particularly between 900° C. and 1100° C. or between 900° C. and 1000° C. The duration of the calcination may be between 30 min and 5 hours, more particularly between 1 hours and 4 hours. The conditions of example 1 (950° C.; 3 hours) may apply.

The preparation of the mixed oxide according to the invention may be based on the conditions of example 1 given below.

The mixed oxide may also be prepared by process (B) which comprises the following steps :
(b1) an acidic aqueous dispersion comprising nitric acid, zirconium oxyhydroxide and precursors of oxides of lanthanum and optionally of a rare-earth metal other than cerium and other than lanthanum, in which an aluminium hydrate is dispersed, is heated and stirred at a temperature which is at least 80° C.;
(b2) an ammonia solution is added to the mixture obtained at the end of step (b1) until the pH of the mixture is at least 8.0;
(b3) an organic texturing agent is then added to the mixture obtained at the end of step (b2) and the mixture is stirred;
(b4) The solid of the dispersion of step (b3) is recovered by a solid/liquid separation and the cake is washed with water;
(b5) the solid obtained at the end of step (b4) is calcined in air at a temperature which is at least 800° C.

### Step (b1)

Use is made of an aqueous acidic dispersion comprising nitric acid, zirconium oxyhydroxide and precursors of lanthanum oxide and optionally of a rare-earth metal other than cerium and other than lanthanum, in which an aluminium hydrate is dispersed. What is disclosed for the precursors of lanthanum oxide and of REM oxide used in process (A) is applicable here too.

The aqueous acidic dispersion contains also contains nitric acid. The concentration of H⁺ in the aqueous acidic dispersion is advantageously between 0.04 and 3.0 mol/l, more particularly between 0.5 and 2.0 mol/l. The amount of H⁺ should be high enough to obtain a dispersion in which the particles of aluminium hydrate are well dispersed.

The precursor of zirconium oxide is zirconium oxyhydroxide. Zirconium oxyhydroxide may generally be represented by formula ZrO(OH)₂. The powder used for the preparation of aqueous acidic dispersion is advantageously characterized by an average size d50 is between 5.0 and 100 µm, more particularly between 5.0 µm and 50.0 µm, even more particularly between 25.0 µm and 40.0 µm or between 28.0 and 30.0 µm. d50 corresponds to the median value of a distribution of size of the particles (in volume) obtained with a laser diffraction particle size analyzer, such as HORIBA LA-920. d50 is generally determined with the dispersion of the oxyhydroxide in water. The oxide content expressed as %wt of ZrO₂ of the zirconium oxyhydroxide is generally between 35.0% and 55.0%. An example of zirconium oxyhydroxide as a precursor of zirconium oxide that may be conveniently used as a raw material is grade TZH-40 commercialized by Terio corporation (18/A, Huaren International Building, 2A Shandong Road, Qingdao, Qingdao, Shandong, China). This grade has the following properties: content expressed in oxide equivalents: ZrO₂+HfO₂>40 wt% min, %ZrO₂ = 43.0 wt%; d50= between 27 µm and 32 µm. More details about this product may be found here: http://www.terio.cn/product/detail/11.

The aqueous acidic dispersion is heated at a temperature which is at least 80° C., more particularly at least 90° C. or even at least 100° C. This temperature may be as high as 200° C. The temperature should be high enough to form a precipitate comprising Zr, La and REM(s) if any.

The aluminium hydrate is preferably the aluminium hydrate H which is disclosed above.

### Step (b2)

An ammonia solution is added to the mixture obtained at the end of step (b1) until the pH of the mixture is at least 8.0.

### Step (b3)

An organic texturing agent is then added to the mixture obtained at the end of step (b2) and the mixture is stirred.

An organic texturing agent (or “template agent”) refers to an organic compound, such as a surfactant, able to modify the porous structure of the mixed oxide, notably on pores the size of which is below 500 nm. The organic texturing agent may be added in the form of a solution or a dispersion. The amount of the organic texturing agent, expressed as percentage by weight of additive relative to the weight of the mixed oxide obtained after the calcination step, is generally between 5 and 100 wt% and more particularly between 15 and 60 wt%.

The organic texturing agent is preferably chosen in the group consisting of: (i) anionic surfactants, (ii) non-ionic surfactants, (iii) polyethylene glycols, (iv) monoacid with an hydrocarbon tail comprising between 7 and 25 carbon atoms, more particularly between 7 and 17, and their salts, and (v) surfactants of the carboxymethylated fatty alcohol ethoxylate type.

As surfactants of anionic type, mention may be made of ethoxycarboxylates, ethoxylated fatty acids, sarcosinates, phosphate esters, sulfates such as alcohol sulfates, alcohol ether sulfates and sulfated alkanolamide ethoxylates, and sulfonates such as sulfo-succinates, and alkylbenzene or alkylnapthalene sulfonates. As non-ionic surfactants, mention may be made of acetylenic surfactants, alcohol ethoxylates, alkanolamides, amine oxides, ethoxylated alkanolamides, long-chain ethoxylated amines, copolymers of ethylene oxide/propylene oxide, sorbitan derivatives, ethylene glycol, propylene glycol, glycerol, polyglyceryl esters and ethoxylated derivatives thereof, alkylamines, alkylimidazolines, ethoxylated oils and alkylphenol ethoxylates. Mention may in particular be made of the products sold under the brands Igepal®, Dowanol®, Rhodamox® and Alkamide®.

The organic texturing acid may also be a mono carboxylic acid with an hydrocarbon tail comprising between 7 and 25 carbon atoms, more particularly between 7 and 17. Mention may be made more particularly of the saturated acids of formula CₙH₂ₙ₊₁COOH with n being an integer between 7 and 25, more particularly between 7 and 17. The following acids may more particularly be used: caproic acid, caprylic acid, capric acid, lauric acid, myristic acid and palmitic acid. Mention may also be more particularly made of lauric acid and ammonium laurate.

Finally, it is also possible to use a surfactant which is selected from those of the carboxymethylated fatty alcohol ethoxylate type. The expression “product of the carboxymethylated fatty alcohol ethoxylate type” is intended to mean products consisting of ethoxylated or propoxylated fatty alcohols comprising a —CH₂—COOH group at the end of the chain.These products may correspond to the formula:

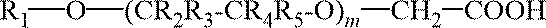

in which R₁ denotes a saturated or unsaturated carbon-based chain of which the length is generally at most 22 carbon atoms, preferably at least 12 carbon atoms; R₂, R₃, R₄ and R₅ may be identical and may represent hydrogen or else R₂ may represent an alkyl group such as a CH₃ group and R₃, R₄ and R₅ represent hydrogen; m is a non-zero integer that may be up to 50 and more particularly between 5 and 15, these values being included. It will be noted that a surfactant may consist of a mixture of products of the formula above for which R₁ may be saturated or unsaturated, respectively, or alternatively products comprising both —CH₂—CH₂—O— and —C(CH₃)═CH₂—O— groups.

The proportion of texturing agent used is generally between 20 wt% and 40 wt%, more particularly between 25% and 35%, this proportion being expressed as percentage by weight of texturing agent relative to the mixed oxide.

### Step (b4)

The solid of the dispersion of step (b3) is recovered by a solid/liquid separation and the cake is washed with water. It is convenient to use a diluted ammonia solution to wash the cake. What is described for step (a3) applies here also.

### Step (b5)

The solid obtained at the end of step (b4) is calcined in air at a temperature which is at least 800° C. What is described for step (a4) applies here also.

The preparation of the mixed oxide according to the invention may be based on the conditions of example 2 given below.

### Step (a5) or (b6)

During a step (a5) or (b6), the mixed oxide which is obtained respectively in step (a4) or in step (b5) may be optionally ground in order to obtain a powder with the desired particle size. Use may for example be made of a hammer mill or a mortar mill. The powder may also be screened in order to control the particle size thereof.

The invention also relates to a mixed oxide capable of being obtained by processes (A) and (B) which have just been described.

### About the Use of the Mixed Oxide

As regards the use of the mixed oxide according to the invention, this comes within the field of motor vehicle pollution control catalysis. The mixed oxide according to the invention may be used in the manufacture of a catalytic converter, the role of which is to treat motor vehicle exhaust gases.

The catalytic converter comprises a catalytically active washcoat prepared from the mixed oxide and deposited on a solid support. The role of the washcoat is to convert, by chemical reactions, certain pollutants of the exhaust gas, in particular carbon monoxide, unburnt hydrocarbons and nitrogen oxides, into products which are less harmful to the environment. The chemical reactions involved may be the following ones:

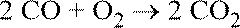

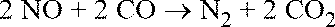

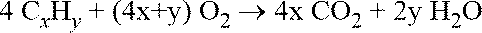

The solid support may be a metal monolith, for example FeCralloy, or be made of ceramic. The ceramic may be cordierite, silicon carbide, alumina titanate or mullite. A commonly used solid support consists of a monolith, generally cylindrical, comprising a multitude of small parallel channels having a porous wall. This type of support is often made of cordierite and exhibits a compromise between a high specific surface and a limited pressure drop.

The washcoat is deposited at the surface of the solid support. The washcoat is formed from a composition comprising the mixed oxide according to the invention and optionally at least one mineral material. The mineral material may be chosen from alumina, boehmite or pseudoboehmite, titanium oxide, zirconium oxide, silica, spinels, zeolites, silicates, crystalline silicon aluminium phosphates or crystalline aluminum phosphates. Alumina is a commonly employed mineral material, it being possible for this alumina to optionally be doped, for example with an alkaline-earth metal, such as barium. According to an embodiment, the washcoat does not contain any cerium oxide (“cerium-free washcoat”). According to another embodiment, the washcoat does not contain any mineral material other than the mixed oxide of the invention.

The composition may also comprise other additives which are specific to each formulator: H₂S scavenger, organic or inorganic modifier having the role of facilitating the coating, colloidal alumina, and the like. The washcoat thus comprises such a composition. The washcoat also comprises at least one dispersed precious metal. The precious metal may be selected in the group consisting of Pt, Rh or Pd. Rh may be used in particular for a washcoat used for the treatment of NOₓ. The amount of precious metal is generally between 1 and 400 g, with respect to the volume of the monolith, expressed in ft³. The precious metal is catalytically active.

In order to disperse the precious metal, it is possible to add a salt of the precious metal to a suspension made of the mixed oxide or of the mineral material (if any) or of the mixture formed of the mixed oxide and of the mineral material. The salt may, for example, be a chloride or a nitrate of the precious metal (e.g. Rh^{lll} nitrate). The water is removed from the suspension, in order to fix the precious metal, the solid is dried and it is calcined in air at a temperature generally of between 300 and 800° C. An example of precious metal dispersion may be found in example 1 of US 7,374,729.

The washcoat is obtained by the application of the suspension to the solid support. The washcoat thus exhibits a catalytic activity and may act as pollution-control catalyst. The pollution-control catalyst may be used to treat exhaust gases from internal combustion engines. The catalytic systems and the mixed oxides of the invention may finally be used as NOₓ traps or for promoting the reduction of NOₓ, even in an oxidizing environment.

For this reason, the invention also relates to a process for treating the exhaust gases from internal combustion engines which is characterized in that use is made of a catalytic converter comprising a washcoat, which washcoat is as described.

### EXAMPLES

### BET Specific Surface Areas

The BET specific surface area are determined automatically on a Macsorb analyzer model I-1220 of Mountech. Prior to any measurement, the samples are carefully degassed to desorb the volatile adsorbed species. To do so, the samples may be heated at 200° C. for 30 min under vacuum in the cell of the appliance.

### Nitrogen Porosity

Use was made of a Tristar II 3000 device from Micromeritics. This device uses physical adsorption and capillary condensation principles to obtain information about the surface area and porosity of a solid material. The nitrogen pore distribution measurement is carried out on 85 points using a pressure table (42 points between 0.01 and 0.995 for the adsorption and 43 points in desorption between 0.995 and 0.05). The equilibrium time for a relative pressure of between 0.01 and 0.995 exclusive is 5 s. The equilibrium time for a relative pressure of greater than or equal to 0.995 is 600 s. The tolerances with regard to the pressures are 5 mm Hg for the absolute pressure and 5% for the relative pressure. The p0 value is measured at regular intervals during the analysis (2 h). The Barrett, Joyner and Halenda (BJH) method with the Harkins-Jura law is used for determining the mesoporosity. The analysis of the results is carried out on the desorption curve.

### X-Ray Diffraction

The x-ray diffraction is performed with a copper source (CuKα1, λ=1.5406 Angstrom). Output power of x-ray was 40 kV / 40 mA. Use was made of a RINT2000 from Rigaku. Use was made of a 2θ angle step = 0.010° and a recording time of 2 seconds per step and an instrumental width s equal to 2θ = 0.11° was determined in the range of the 2θ angles from 28 to 32°.

The intensities were determined on the diffractograms relative to a baseline taken over the 2θ angle range between 26.0° and 32.0°. The baseline was determined automatically using the software for analyzing the data of the diffractogram.

### Aluminium Nitrate H (93.6% Al₂O₃ - 6.4% La₂O₃)

The aluminium nitrate H was prepared according to the teaching of example 1 of WO 2019/122692. Characterisations of the aluminium hydrate H
composition: 67.3% Al₂O₃ - 4.6% La₂O₃- LOI 28.1 % (Loss On Ignition) which corresponds to 93.6% Al₂O₃ - 6.4% La₂O₃;
this powder has a BET surface area of 344 m²/g.
other characteristics:

| BET specific surface area after calcination in air at 900° C. - 2 h (m²/g) | X-ray analysis | | Pore volumes (N₂-porosity) after calcination in air at 900° C.- 2 h | | |
|---|---|---|---|---|---|
| | [020] XRD crystallite size (nm) | crystallinity [120] XRD peak | VPT-N₂ (ml/g) | VP₂₀ ₙₘ-N₂ / VPT-N₂ (%) | VP₄₀-₁₀₀ nm⁻ N₂/ VPT-N₂ (%) |
| 181 | 2.8 | 47% | 1.09 | 36% | 32% |

### Example 1: Preparation of a Mixed Oxide Al₂O₃ (30%) - ZrO₂ (60%) - La₂O₃ (5%) - Y₂O₃ (5%) (% by Weight) with Process (A)

A solution containing the precursors of the oxides of Zr, La and Y was prepared by introducing into a stirred tank, 37.1 kg of a zirconyl nitrate solution ([ZrO₂] = 295 g/l; density = 1.461), 1.79 kg of a lanthanum nitrate solution ([La₂O₃] = 321.1 g/l; density = 1.511), 4.02 kg of a yttrium nitrate solution ([Y₂O₃] = 219.7 g/l; density = 1.414) and 16.9 kg of a 60 wt% nitric acid solution. The volume was adjusted to a total amount of 85 L with deionized water. Next, 5.49 kg of the aluminium hydrate H disclosed above containing an equivalent of 68.3% by weight of alumina (3.75 kg Al₂O₃) and 4.6% by weight of La₂O₃ (0.25 kg) was introduced under agitation to the solution obtained, and the total amount of the mixture thus obtained was adjusted at 125 L with deionized water. The concentration of H⁺ in the aqueous acidic dispersion so prepared was 1.3 mol/l. The aqueous acidic dispersion was kept under stirring for 3 hours.

The aqueous acidic dispersion was then introduced in 60 min into a reactor stirred by a spindle with three blades (225 rpm), containing 125 L of a 4.5 mol/l ammonia solution at ambient temperature. At the end of the addition of the dispersion, the mixture is heated to a temperature of 150° C. and maintained at this temperature for 2 hours. The mixture is then cooled to a temperature below 50° C.

The medium is filtered on a press filter at a pressure of around 4 bar, then the cake is washed with 20 L of deionized water. The cake is then compacted at a pressure of 19.5 bar for 10 min. The wet cake obtained is then introduced into a electric furnace. The product is calcined at 950° C. for 3 hours. The mixed oxide recovered is then ground in a blade mill of “Forplex” type.

### Example 2: Preparation of a Mixed Oxide Al₂O₃ (30%) - ZrO₂ (60%) - La₂O₃ (5%) - Y₂O₃ (5%) (% by Weight) with Process (B)

A solution containing the precursors of the oxides of La and Y was prepared by introducing into a reactor stirred by a spindle with three blades, 1.12 kg of a lanthanum nitrate solution ([La₂O₃] = 343.1 g/l; density = 1.541), 2.75 kg of a yttrium nitrate solution ([Y₂O₃] = 219.1 g/l; density = 1.417) and 24.5 kg of a 60 wt% nitric acid solution. The volume was adjusted to a total amount of 150 L with deionized water. Next, 11.9 kg of the oxyhydroxide TZH-40 commercialized by Terio corporation (d50= between 27 µm and 32 µm; containing an equivalent of 43.0% by weight of zirconium oxide; this corresponds thus to 5.1 kg ZrO₂) and 3.79 kg of the aluminium hydrate H disclosed above containing an equivalent of 67.3% by weight of alumina (2.55 kg Al₂O₃) and 4.6% by weight of La₂O₃ (0.18 kg) were introduced under agitation into the solution obtained, and the total amount of the mixture thus obtained is adjusted at 170 L with deionized water.

The aqueous acidic dispersion so prepared is heated to a temperature of 100° C. and maintained at this temperature for 4 hours. After the mixture is cooled to 50° C., 25% ammonia solution is introduced under agitation until a pH=8.4 is obtained, then after 10 min, 2.55 kg of lauric acid (corresponding to a ratio of lauric acid/mixed oxide of 30 wt%).

The medium is filtered on a press filter at a pressure of around 4 bar, then the cake is washed with 85 L of deionized water. The cake is then compacted at a pressure of 19.5 bar for 10 min. The wet cake obtained is then introduced into a electric furnace. The product is calcined at 950° C. for 3 hours. The mixed oxide recovered is then ground in a blade mill of “Forplex” type.

### Example 3: Preparation of a Mixed Oxide Al₂O₃ (30%) - ZrO₂ (60%) - La₂O₃ (5%) - Y₂O₃ (5%) (% by Weight) with Process (A)

The mixed oxide is prepared in the same way as in Example 1 except that the agitation time of the precursor mixture is decreased from 3 to 1 hour.

### Example 4: Preparation of a Mixed Oxide Al₂O₃ (30%) - ZrO₂ (60%) - La₂O₃ (5%) - Y₂O₃ (5%) (% by Weight) with Process (A)

The mixed oxide is prepared in the same way as in Example 1 except that the concentration of ammonia solution is decreased from 4.5 to 3.5 mol/l.

### Example 5: Preparation of a Mixed Oxide Al₂O₃ (30%) - ZrO₂ (60%) - La₂O₃ (5%) - Y₂O₃ (5%) (% by Weight) with Process (A)

The mixed oxide is prepared in the same way as in Example 1 except that:
the quantity of 60% nitric acid solution is decreased from 16.9 to 0.44 kg.
the concentration of ammonia solution is decreased from 4.5 to 2.2 mol/l.

With the conditions of examples 1-5, it is possible to obtain other mixed oxides with compositions according to claim 1.

### Comparative Example 1: Preparation of a Mixed Oxide Al₂O₃ (30%) - ZrO₂ (60%) - La₂O₃(5%) - Y₂O₃ (5%) (% by Weight)

The mixed oxide is prepared in the same way as in Example 1 except that,
the agitation time of the precursor mixture is decreased from 3 to 1 hour.
the mixture obtained after the reaction with ammonia solution is heated to a temperature of 100° C. and maintained at this temperature for 2 hours.

### Comparative Example 2: Preparation of a Mixed Oxide Al₂O₃ (30%) - ZrO₂ (60%) - La₂O₃(5%) - Y₂O₃ (5%) (% by Weight)

The mixed oxide is prepared in the same way as in Example 1 except that:
the agitation time of the precursor mixture is decreased from 3 hours to 10 min;
- 25% ammonia solution is introduced into the precursor mixture under agitation until a pH=8.5 is obtained;
no thermal ageing of the mixture is conducted.

TABLE I

| Ex. | BET specific surface areas (m²/g) | | | crystallite size (nm) after calcination in air at | | porosity of the mixed oxide after calcination at 950° C. for 3 hours | | | |
|---|---|---|---|---|---|---|---|---|---|
| | S_{950°C} _{/3} ₕ | S_{1100°} _{C/5} ₕ | S_{1200°} _{C/5} ₕ | 1100° C./ 5 h | 1200° C./ 5 h | Dₚ _{950°C/3} ₕ (nm)* | V_{<30,950°C} _{/}Vₜₒₜₐₗ, _{950°C}, _{N2} | V_{total,950°C} _{/3} _{h,} _{N2} _{(ml/g)} | width at half peak of the peak at Dₚ * _{950°C/3h}* (nm) |
| Ex. 1 | 87 | 31 | 13 | 26 | 37 | 17 | 0.91 | 0.46 | 7 |
| Ex. 2 | 93 | 33 | 11 | 21 | 31 | 15 | 0.91 | 0.43 | 9 |
| Ex. 3 | 83 | 30 | 12 | 28 | 39 | 17 | 0.91 | 0.45 | 8 |
| Ex. 4 | 81 | 32 | 11 | 24 | 37 | 17 | 0.94 | 0.41 | 8 |
| Ex. 5 | 85 | 35 | 14 | 23 | 32 | 21 | 0.90 | 0.51 | 8 |
| Cex. 1 | 85 | 24 | 8 | 25 | 32 | 13 | 0.93 | 0.31 | 6 |
| Cex. 2 | 85 | 20 | 7 | 24 | 36 | 27 | 0.89 | 0.23 | 5 |

all calcinations in air
* a single peak located in the domain of the pores with a size lower than 100 nm

One can notice that it is possible to obtain a low crystallite size with process (B). One can also notice that it is possible to finetune the porosity of the mixed oxide so as to obtain a Dₚ, _{950°C} _{/ 3h} below 25 nm and a ratio V_{<30} _{nm,} _{950°C/3h} / Vₜₒₜₐₗ, _{950°C/3h} > 0.85. It is also possible to obtain a narrow peak below 25 nm.

1. A mixed oxide composition comprising a mixed oxide of aluminium, of zirconium, of lanthanum and optionally of at least one rare-earth metal other than cerium and other than lanthanum (denoted REM), wherein the proportions by weight of these elements expressed as oxide equivalent with respect to a total weight of the mixed oxide composition are as follows:
between 20.0 wt% and 45.0 wt% of aluminium;
between 1.0 wt% and 15.0 wt% of lanthanum;
between 0 and 10.0 wt% of at least one REM, on condition that if the mixed oxide composition comprises more than one REM, this proportion applies to each of these rare-earth metals; and
between 50.0 wt% and 70.0 wt% of zirconium;
wherein the mixed oxide composition is characterized in that after calcination in air at 1100° C. for 5 hours, has a specific surface area (BET) ranging from at least 25 m²/g to at most 40 m²/g; and wherein after calcination in air at 950° C. for 3 hours, a porosity of the mixed oxide composition determined by N₂ porosimetry is such that:
in a domain of the pores with a size lower than 100 nm, a porogram of the mixed oxide composition exhibits a peak which is located at a diameter D_{p,} _{950°C/3} ₕ between 10 and 25 nm;
a ratio V_{<30} _{nm,} _{950°C/3h} / V_{total,} _{950°C/3h} is greater than or equal to 0.85;
V_{total,} _{950°C/3h} is greater than or equal to 0.35 ml/g;
wherein V_{<30} _{nm,} _{950°C/3h} and V_{total,} _{950°C/3h} denote a pore volume for the pores with a size lower than 30 nm and a total pore volume of the mixed oxide composition after calcination in air at 950° C. for 3 hours, respectively.

2. The mixed oxide composition according to claim 1, wherein the mixed oxide consists of a combination of the oxides of aluminium, of zirconium, of lanthanum, optionally of at least one rare-earth metal other than cerium and other than lanthanum (denoted REM), and optionally of further hafnium in a proportion lower than or equal to 2.0 wt%, wherein this proportion is expressed as HfO₂ with respect to a total weight of the mixed oxide composition.

3. (canceled)

4. The mixed oxide composition according to claim 1 wherein the elements selected from the group of Ce, Zr, La, REM, if any, and Hf, if any, are present in the mixed oxide composition as oxides, and partially as hydroxides or oxyhydroxides.

5. (canceled)

6. (canceled)

7. The mixed oxide composition according to claim 1 wherein after calcination in air:
at 1100° C. for 5 hours, a mean size of the crystallites of a crystalline phase based on zirconium oxide is at most 28 nm; and/or
at 1200° C. for 5 hours, a mean size of the crystallites of a crystalline phase based on zirconium oxide is at most 44 nm.

8. (canceled)

9. (canceled)

10. The mixed oxide composition according to claim 1 wherein the after calcination in air of the mixed oxide composition, a crystalline phase forms, wherein the crystalline phase is characterized by a peak located at a 2θ angle between 29° and 31° (source: CuKα1, λ=1.5406 Angstrom).

11. (canceled)

12. The mixed oxide composition according to claim 1 wherein after calcination in air of the mixed oxide composition, a crystalline phase exhibiting a tetragonal structure forms, wherein the crystalline phase comprises zirconium oxide, lanthanum and optionally the rare-earth metal(s) other than cerium and other than lanthanum.

13. (canceled)

14. (canceled)

15. (canceled)

16. (canceled)

17. (canceled)

18. (canceled)

19. (canceled)

20. The mixed oxide composition according to claim 1 wherein the a total proportion of zirconium and aluminium is greater than or equal to 80.0 wt%.

21. (canceled)

22. The mixed oxide composition according to claim 1 characterized in that if the mixed oxide contains more than one REM, a total proportion of the REMs is less than 25.0 wt%.

23. (canceled)

24. (canceled)

25. The mixed oxide composition according to claim 1 wherein:
the proportion of lanthanum is between 2.0 wt% and 7.0 wt%,; and/or
the proportion of the REM is between 2.0 wt% and 7.0 wt%.

26. (canceled)

27. The mixed oxide composition according to claim 1 wherein the REM or one of the REMs is selected from yttrium, neodymium, praseodymium or a combination of these elements.

28. (canceled)

29. The mixed oxide composition according to claim 1 characterized in that it does not comprise cerium or cerium oxide.

30. The mixed oxide composition according to claim 1 characterized in that a proportion of cerium expressed by weight of oxide CeO₂ with respect to the total weight of the mixed oxide composition is less than 1.0 wt%.

31. (canceled)

32. (canceled)

33. (canceled)

34. The mixed oxide composition according to claim 1 wherein the specific surface area (BET) after calcination in air at 950° C. for 3 hours ranges from is at least 65 m²/g to at most 110 m²/g.

35. (canceled)

36. The mixed oxide composition according to claim 1 wherein the specific surface area (BET) after calcination in air at 1200° C. for 5 hours is at least 9 m²/g.

37. (canceled)

38. (canceled)

39. (canceled)

40. The mixed oxide composition according to claim 1 wherein the peak is a single peak characterized by a width which is at most 10 nm.

41. (canceled)

42. A process of preparation of a the mixed oxide composition according to claim 1, the process comprising the following steps:
(a1) an acidic aqueous dispersion comprising nitric acid and precursors of oxides of zirconium, of lanthanum and optionally of a REM, in which an aluminium hydrate is dispersed, is introduced into a stirred tank containing a basic aqueous solution;
(a2) the dispersion obtained at the end of step (a1) is heated and stirred at a temperature which is at least 130° C. with the formation of a solid;
(a3) the solid of the dispersion of step (a2) is recovered by a solid/liquid separation and the a cake is washed with water;
(a4) the solid obtained at the end of step (a3) is calcined in air at a temperature which is at least 800° C.

43. A process of preparation of a the mixed oxide composition according to claim 1 comprising the following steps:
(b1) an acidic aqueous dispersion comprising nitric acid, zirconium oxyhydroxide and precursors of oxides of lanthanum and optionally of a REM, in which an aluminium hydrate is dispersed, is heated and stirred at a temperature which is at least 80° C. with the formation of a mixture;
(b2) an ammonia solution is added to the mixture obtained at the end of step (b1) until the a pH of the mixture is at least 8.0;
(b3) an organic texturing agent is then added to the mixture obtained at the end of step (b2) and the mixture is stirred with the formation of a solid;
(b4) the solid of the dispersion of step (b3) is recovered by a solid/liquid separation and the a cake is washed with water;
(b5) the solid obtained at the end of step (b4) is calcined in air at a temperature which is at least 800° C.

44. A process of preparation of the mixed oxide composition according to claim 1 comprising dispersing an aluminium hydrate in an acidic aqueous dispersion comprising nitric acid and precursors of oxides of zirconium, of lanthanum and optionally of a REM, wherein the aluminum hydrate is an aluminium hydrate H based on a boehmite optionally comprising also lanthanum wherein the aluminum hydrate exhibits after calcination in air at a temperature of 900° C. for 2 hours, the following porosity:
a) a pore volume in the a domain of pores having a size of less than or equal to 20 nm (denoted by VP20 nm-N2), such that VP20 nm-N2:
is greater than or equal to 10% x VPT-N2;
is less than or equal to 60% x VPT-N2;
b) a pore volume in the a domain of the pores having a size of between 40 and 100 nm (denoted by VP40-100 nm-N2), such that VP40-100 nm-N2 is greater than or equal to 20% x VPT-N2;
■ VPT-N2 denoting the a total pore volume of the aluminium hydrate after calcination in air at 900° C. for 2 hours;
wherein the pore volumes are determined by a nitrogen porosimetry technique.

45. (canceled)

46. (canceled)

47. (canceled)

48. The mixed oxide composition according to claim 1 further comprising at least one precious metal selected from the group consisting of Pt, Rh or Pd and optionally at least one mineral material.

49. (canceled)

50. A catalytic converter comprising a catalytically active washcoat prepared from a the mixed oxide composition according to claim 1, wherein the mixed oxide composition is deposited on a solid support.

51. (canceled)

52. (canceled)

53. (canceled)

54. (canceled)

55. (canceled)

56. (canceled)
